(19) United States
(12) Patent Application Publication
(10) Pub. No.: US 2013/0099463 A1
(43) Pub. Date: Apr. 25, 2013

(54) DEVICE AND METHOD FOR PARKING A TWO-WHEELED VEHICLE UPRIGHT

(71) Applicant: Benny Tobie, Kibuts Mayan-Baruch (IL)

(72) Inventor: Benny Tobie, Kibuts Mayan-Baruch (IL)

(21) Appl. No.: 13/696,639

(22) PCT Filed: Aug. 11, 2010
(86) PCT No.: PCT/IL10/00647

§ 371 Date: Dec. 24, 2012

(51) Int. Cl. B62H 7/00

(52) U.S. Cl. CPC B62H 7/00
USPC 280/293

(57) ABSTRACT

In one aspect the present invention is directed to a device for parking a first two-wheeled vehicle (10) upright, the device comprising: a connector (2), for connecting, during the parking, the first two-wheeled vehicle (10) to a side member selected from a group including: a second two-wheeled vehicle (32), another object (32a); wherein the supporting point (4) of the side member being disposed above the ground level.

### FIELD OF THE INVENTION

The present invention relates to the field of bicycles. More particularly, the invention relates to a device and method and apparatus for parking a two-wheel vehicle upright.

### BACKGROUND OF THE INVENTION

The term “two-wheeled vehicle” refers to a bicycle or to a motorcycle or other vehicles having two wheels only, thus which need additional support for making them stand.

A kickstand is a device that allows a two-wheeled vehicle to be kept upright without leaning against another object or the aid of a person. It includes a piece of metal that flips down from one side of the frame of the two-wheeled vehicle and makes contact with the ground.

As such, kickstands have not provided satisfactory solution to the problem of reliable keeping of bicycles upright when parking.

It is an object of the present invention to provide a solution to the above-mentioned and other problems of the prior art.

Other objects and advantages of the invention will become apparent as the description proceeds.

### SUMMARY OF THE INVENTION

In one aspect the present invention is directed to a device for parking a first two-wheeled vehicle (10) upright, the device comprising:
a connector (2), for connecting, during the parking, the first two-wheeled vehicle (10) to a side member selected from a group including: a second two-wheeled vehicle (32), another object (32a);
wherein the supporting point (4) of the side member being disposed above the ground level.

The connecting of the first two-wheeled vehicle (10) to the side member (32, 32a) may comprise connecting (FIG. 2) the first two-wheeled vehicle (4 of 10) to the connector (2).

The connector (2) may comprise a first (34) and a second (34) grasp mounted together, the first grasp for grasping the first two-wheeled vehicle (10), and the second grasp for grasping the side member (32, 32a).

The mounting together of the first (34) and second (34) grasps may comprise at least one hinge (36), for adjusting therebetween.

The connecting of the first two-wheeled vehicle (10) to the side member (32, 32a) may comprise connecting a first connecting member (8 in FIG. 10) of the connector (6 & 8) to a second connecting member (6 in FIG. 9) of the connector (6 & 8),

wherein the first connecting member (8) is mounted to the first two-wheeled vehicle (4 of 10).

The connector may comprise:
the first connecting member (8) mounted to a handle (4) of the first two-wheeled vehicle, the first connecting member comprising a first half (14 in FIG. 10) of connecting means; and
a second connecting member (6) mounted to the side member (32, 32a) substantially at the height of the handle (4) of the first two-wheeled vehicle, the second connecting member (6) comprising a second half (12 in FIG. 10) of the connecting means.

The connecting means between the two halves (12, 14) may comprise elastic means.

The connecting means between the two halves (12, 14) may comprise magnetic means.

The first half of the connecting means may comprise a male edge (14) and the second half of the connecting means may comprise a corresponding female edge (12).

The mounting of the first connecting member (8) to the handle (4) may comprise insertion of the handle into an elastic sleeve (22) of the first connecting member (8).

The mounting of the first connecting member (8) to the handle (4) may comprise insertion of a wedge anchor (18, 20) of the first connecting member (8) into the inner space of the handle (4), expanding a clip (20) of the wedge anchor against the sidewalls of the inner space.

The first connecting member (8) and the second connecting member (6) may comprise a combination selected from the following:
first connecting member is straight and second connecting member is bent,
the first connecting member is straight and the second connecting member is straight,
the first connecting member is bent and the second connecting member is bent,
the first connecting member is bent and the second connecting member is straight.

The second connecting member (6) may comprise:
a third connecting member (22 in FIG. 5) identical to the first connecting member (22); and
a linker (24), for linking the first connecting member (22) to the third connecting member (22), the linker comprising connecting means (12) corresponding to the connecting means (14) of the first (22) and third (22) connecting members, for connecting between the first connecting member (22) and the linker (24), and for connecting between the third connecting member (22) and the linker (24).

The device may further comprise:
a brake limiter, for limiting the brake of said first two-wheeled vehicle during the parking,
thereby avoiding sliding of the first two-wheeled vehicle during said parking.

The first and second grasps may comprise at least one torque quick coupling.

The first and second grasps may be identical components.

In another aspect the present invention is directed to a method for parking a first two-wheeled vehicle (10) upright, the method comprising the step of:
connecting the first two-wheeled vehicle (10) to a side member selected from a group including: a second two-wheeled vehicle (32), another object (32a);
wherein the supporting point (4) of the side member being disposed above the ground level.

The method may further comprise the step of:
disconnecting of the connecting of the first two-wheeled vehicle (10) to the side member (32, 32a).

The step of connecting may comprise the steps of:
connecting a linker (24) to the first two-wheeled vehicle (10); and
connecting the linker to the side member (32, 32a).

The method may further comprise the step of:
limiting the brake of said first two-wheeled vehicle to the braked state thereof,
   thereby avoiding sliding of said first two-wheeled vehicle during said parking.

The forgoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 shows a bicycle connector, according to one embodiment of the present invention.

FIG. 2 shows the bicycle connector of FIG. 1 grasping the two handles.

FIG. 3 shows the connecting of the two handles of FIG. 2, for connecting two bicycles.

FIG. 4 shows a sleeve of a bicycle connector, according to another embodiment of the present invention.

FIG. 5 shows connection of the sleeves of FIG. 4.

FIG. 6 shows the bicycle connector of FIG. 4, engaged and threaded on bicycle handles.

FIG. 7 shows the connecting of the two handles of FIG. 5, for connecting two bicycles.

FIG. 8 shows a bicycle connector, according to another embodiment of the present invention.

FIGS. 9 and 10 show a bicycle connector, according to another embodiment of the present invention.

FIGS. 11 and 12 show a bicycle connector, according to another embodiment of the present invention.

FIG. 13 shows a bicycle connector, according to another embodiment of the present invention.

FIG. 14 shows a wall mounted device for a bicycle, according to one embodiment of the present invention, which is based on one of the connectors,

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known methods, systems, procedures, components, circuits, and so on, have not been described in detail.

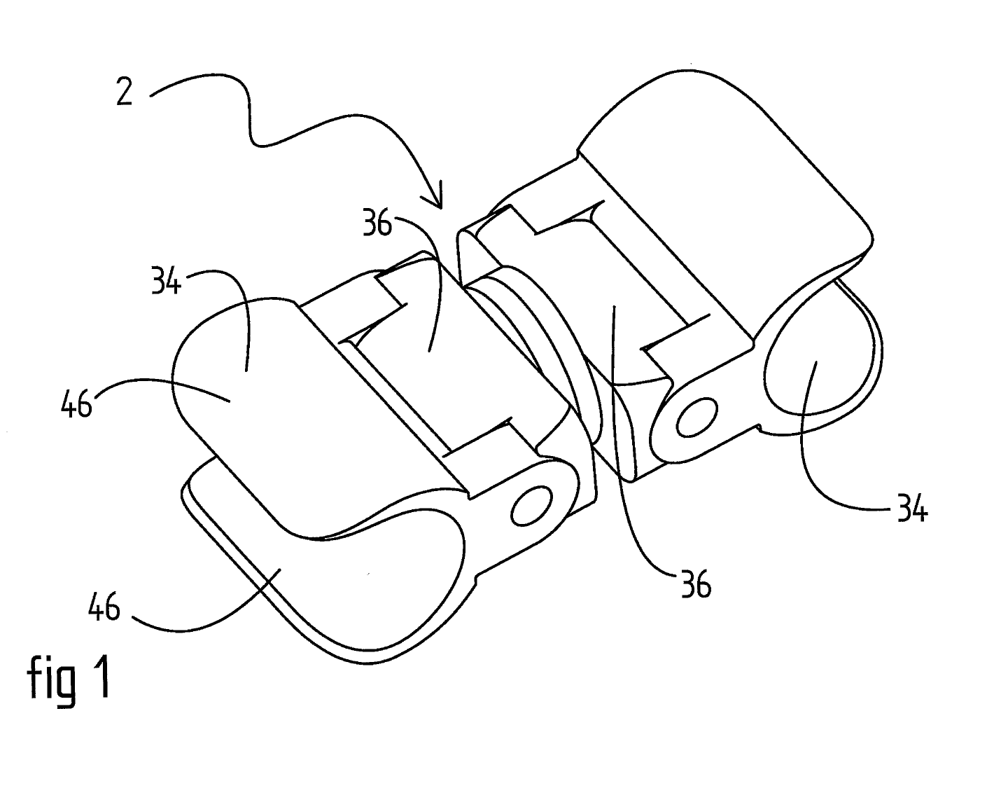

FIG. 1 shows a bicycle connector, according to one embodiment of the present invention.

A bicycle connector 2 includes two grasps 34, one for grasping a handle or another rod of a first bicycle on the left, and the other for grasping a handle or another rod of a second bicycle on the right.

Each of grasps 34 includes two elastic reeds 46 for grasping the handle of the bicycle.

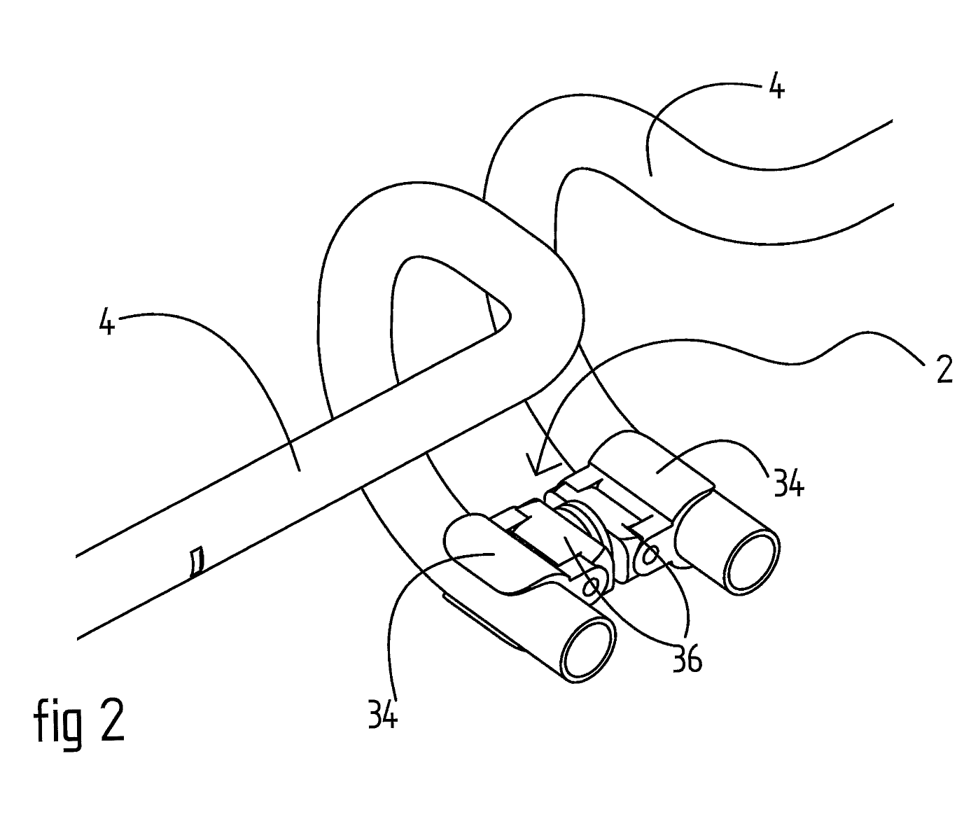

FIG. 2 shows the bicycle connector of FIG. 1 grasping the two handles.

Handle 4 of the bicycle is pressed between the two reeds 46 for insertion thereof. The distance between reeds 46, since being elastic, is enlarged until insertion, and decreased back, grasping handle 4.

Elastic reeds 46 provide that the connection between bicycle 10 and bicycle 32 may be disconnected.

Hinges 36 may allow adjustment of the angle, such as for matching height differences between the bicycles.

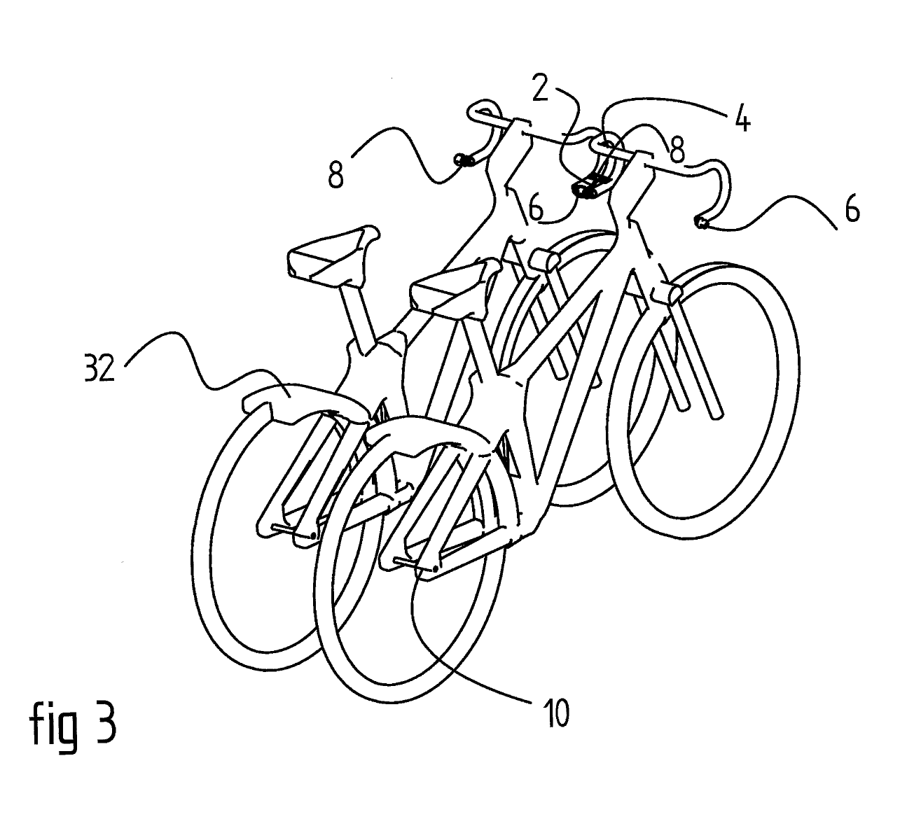

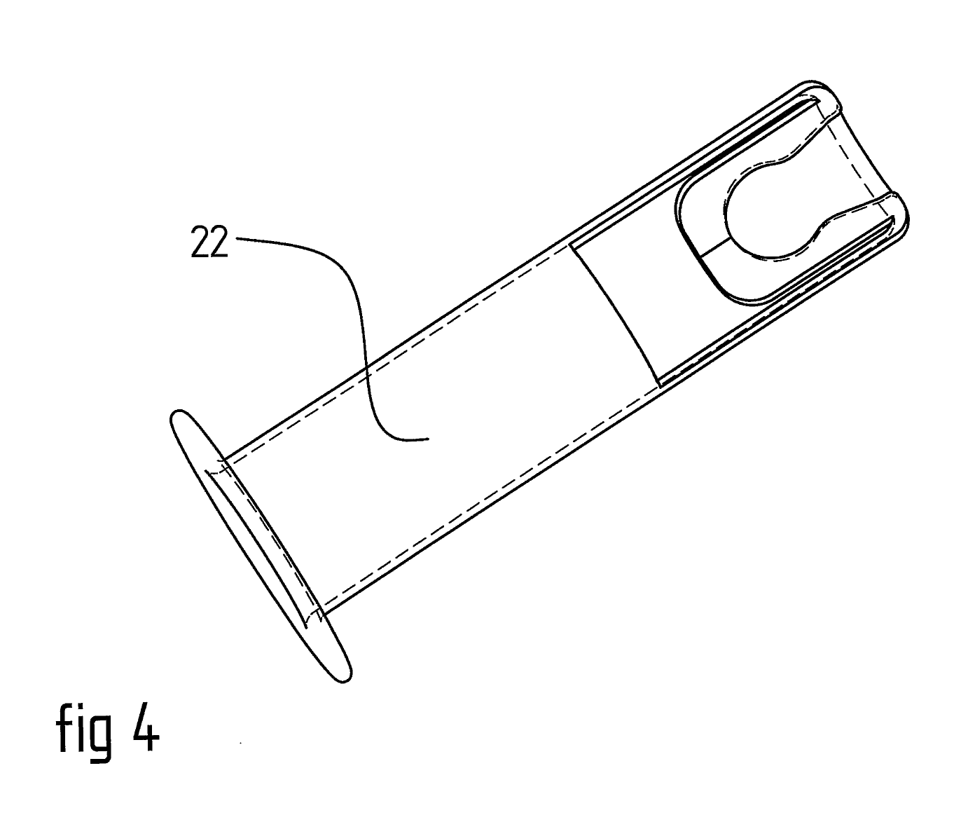

FIG. 3 shows the connecting of the two handles of FIG. 2, for connecting two bicycles.

Bicycle 32 is located at the side of bicycle 10 and holds bicycle 10 upright. Other objects at the side of bicycle 10, rather than bicycle 32, may also hold bicycle 10 upright.

Bicycle connector 2 of FIG. 1 or a bicycle connector 2 having another form is depicted connecting the right handle 4 of a left bicycle 32 to a left handle 4 of a right bicycle 10, thus parking the two bicycles 10 and 32 upright.

Bicycle 10, bicycle 32 and connector 2 form together a four sided frame, which is steadier than bicycle 10 alone having a kickstand. Unlike a kickstand, the supporting point of bicycle 32, which is handle 4, is disposed above the ground level.

FIGS. 1 to 3 depict connection of bent handles.

FIG. 4 shows a sleeve of a bicycle connector, according to another embodiment of the present invention.

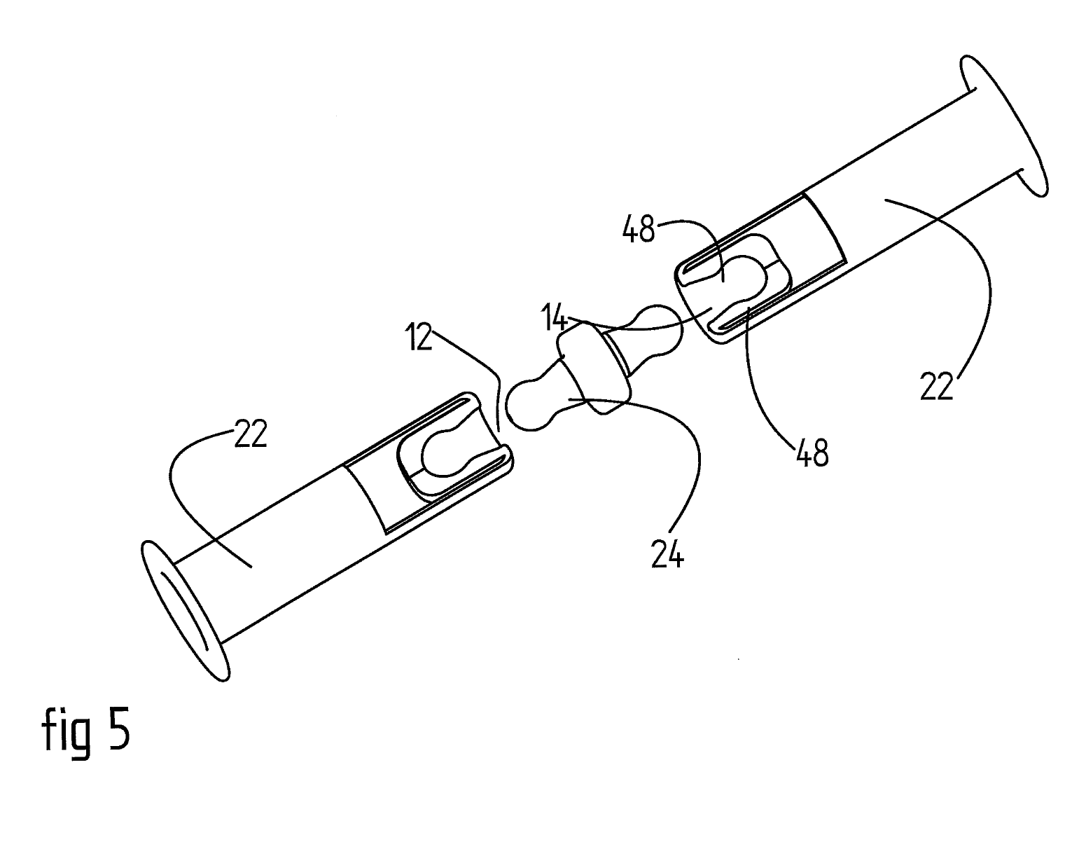

FIG. 5 shows connection of the sleeves of FIG. 4.

The bicycle connector of FIG. 5 as depicted is suited for straight handles of bicycles.

It includes two sleeves 22, one for each handle of a bicycle, and a linker 24, for linking the two sleeves 22.

Sleeves 22 replace the standard sleeves of the handles of the bicycle, and also they are attached by elastic and friction forces of the sleeve towards handle 4.

According to the depicted embodiment linker 24 is a male component from both sides thereof and each of sleeves 22 includes a female edge 14 at the connecting side. According to another embodiment linker 24 is a female component from both sides thereof and each of sleeves 22 includes a male edge 12 at the connecting side.

The advantage of a bicycle connector having three parts is the standardization of all of sleeves 22 for all bicycles, such that all sleeves 22 will be have male edges 12, or all sleeves 22 will have female edges 12.

According to another embodiment linker 24 is a male component from one side and female component from the other side, and each of sleeves 22 includes a corresponding male or female edge at the connecting side.

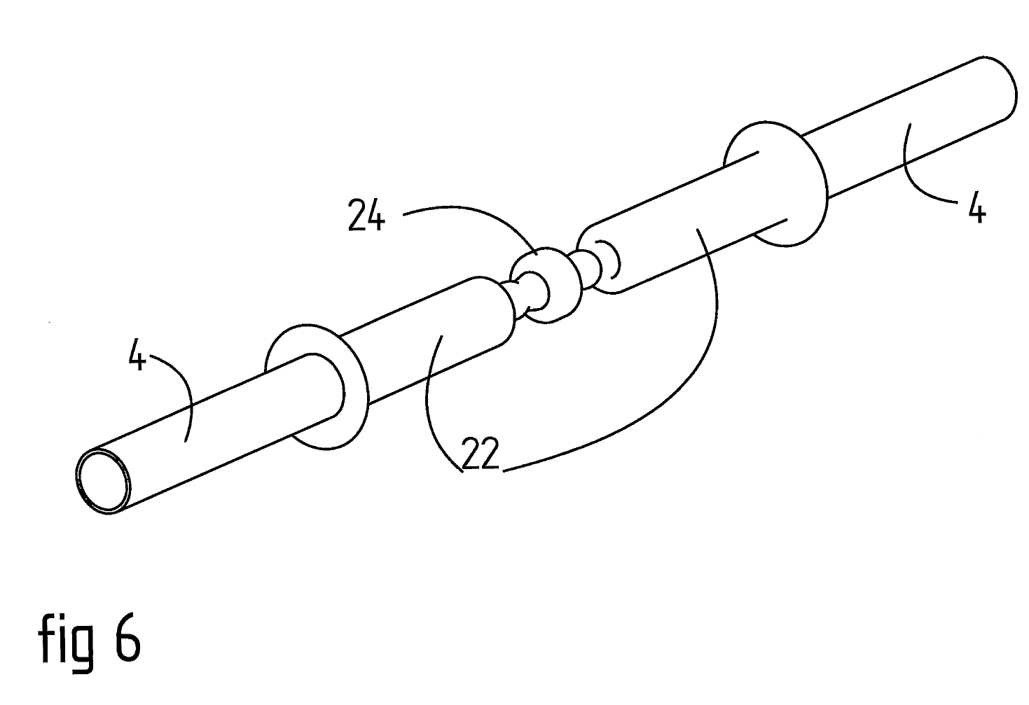

FIG. 6 shows the bicycle connector of FIG. 4, engaged and threaded on bicycle handles.

The right handle 4 of the right bicycle is inserted into the left sleeve 22; the left handle 4 of the left bicycle is inserted into the left sleeve 22; and linker 24 engages the two sleeves 22 by elastic reeds 48 grasping linker 24.

Linker 24 may engage sleeves 22 to female edge 14 of sleeves 22 by magnetic means or by elastic means of, or other means.

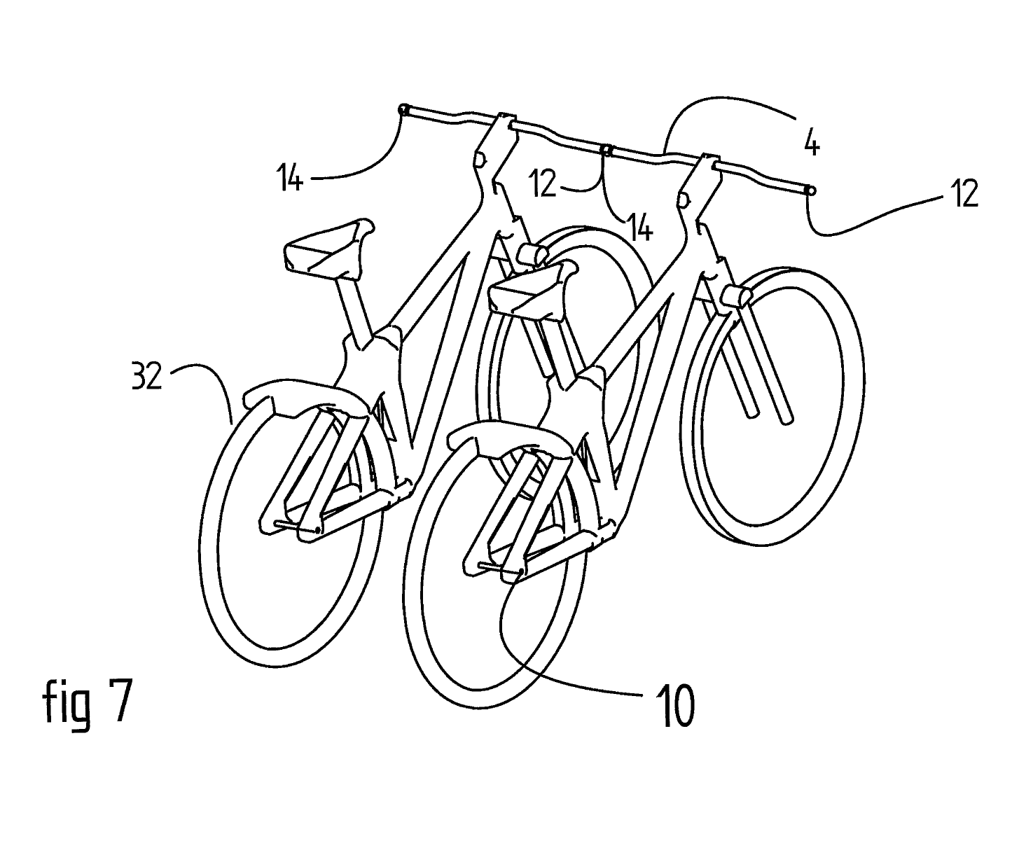

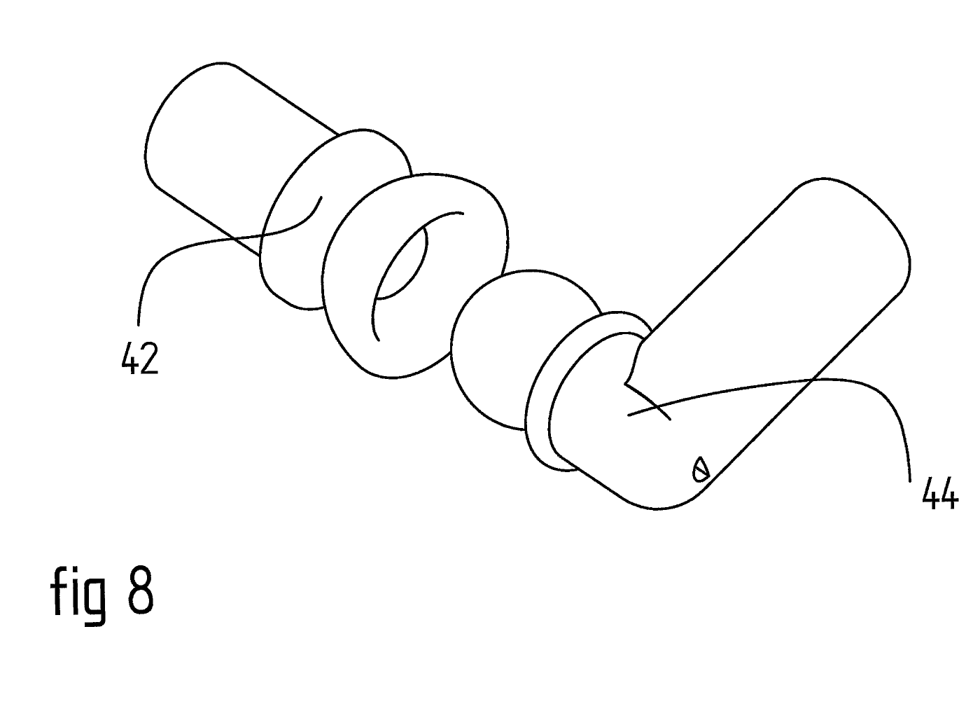

FIG. 7 shows the connecting of the two handles of FIG. 5, for connecting two bicycles.

The bicycle connector of FIG. 5 or a bicycle connector having another form is depicted connecting the right handle 4 of a left bicycle 10 to a left handle 4 of a right bicycle 10, thus parking the two bicycles 10 upright.

Preparations for connecting handles 4 may be mounted. For example, the left handle of left bicycle may have a female edge preparation 14 to engage another bicycle from the left using the connector of FIG. 4, and the right handle of the right bicycle may have a male edge preparation 12 to engage another bicycle from the right, using another connector of FIG. 4.

FIG. 8 shows a bicycle connector, according to another embodiment of the present invention.

The connector of FIG. 8 includes a male member 44 and a female member 42, engaged by magnetic means or by elastic means of female member 42, or other means.

The connector depicted in FIG. 8, in which member 44 is bent and member 42 is straight is for connecting a bicycle having a bent handle to another bicycle having a straight handle.

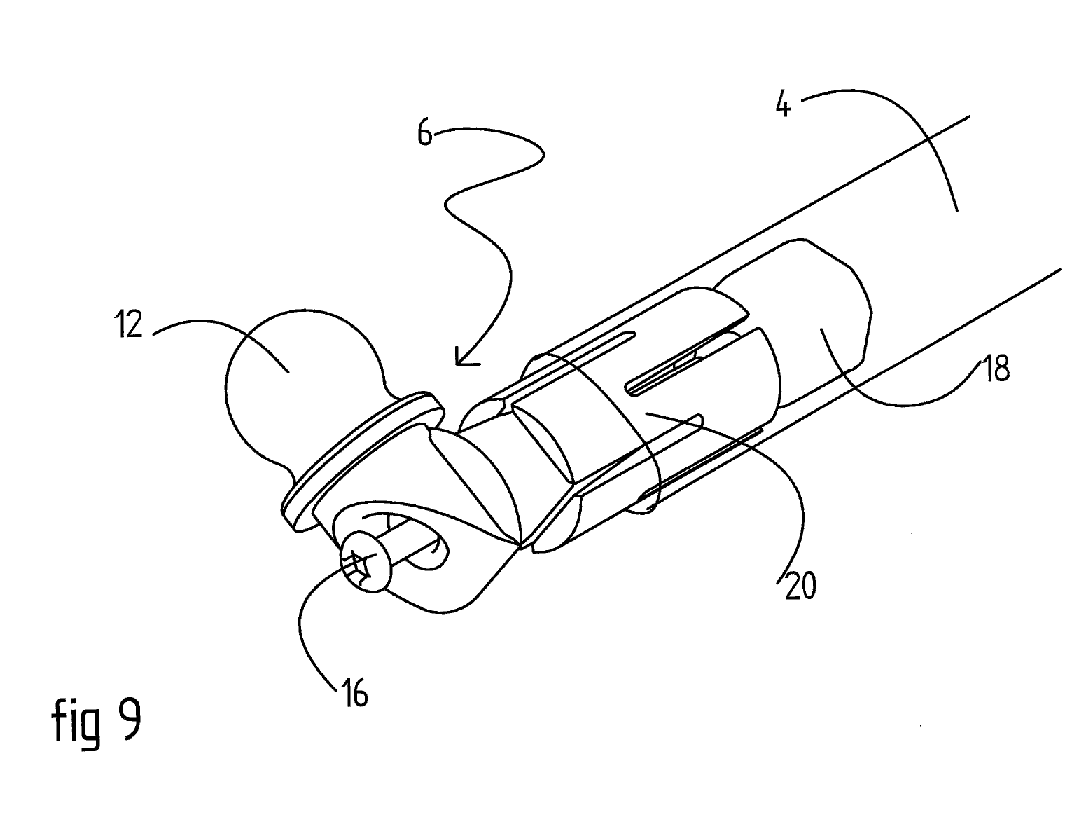

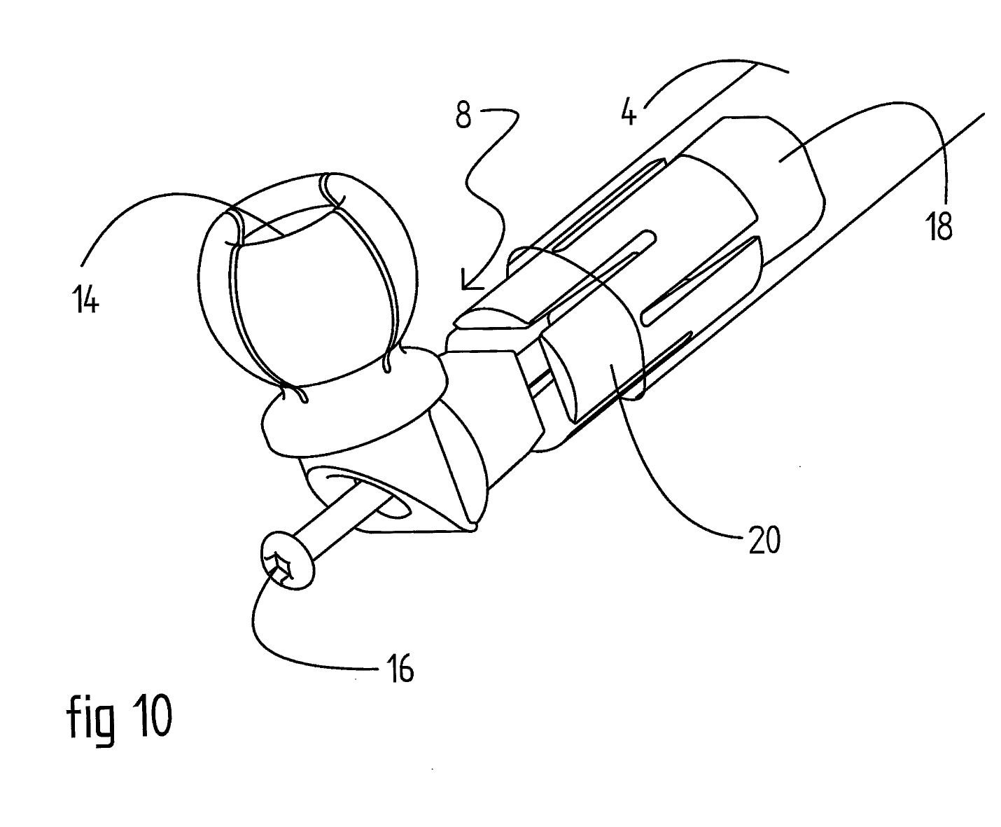

FIGS. 9 and 10 show a bicycle connector, according to another embodiment of the present invention.

The connector of the present embodiment includes a male member 6 having a male edge 12, and a female member 8 having a female edge 14.

Like male member 44 of FIG. 8, male member 6 also is bent for connecting a bicycle having a bent handle. Also the depicted female member 8 is bent for connecting a bicycle having a bent handle.

Unlike FIG. 6 in which handle 4 of the bicycle is inserted into sleeve 22 of the connector, each of members 6 and 8 of the present embodiment is inserted into the hollow cylinder of the handle 4 thereof.

Each of members 6 and 8 includes the components of a wedge anchor, for attaching the member to handle 4 thereof. Namely they include a screwed conical anchor 18, a nut 16 pulling anchor 18 through torque, and a clip 20 which expands against the side walls of the inner space of handle 4, upon pulling anchor 18 towards clip 20.

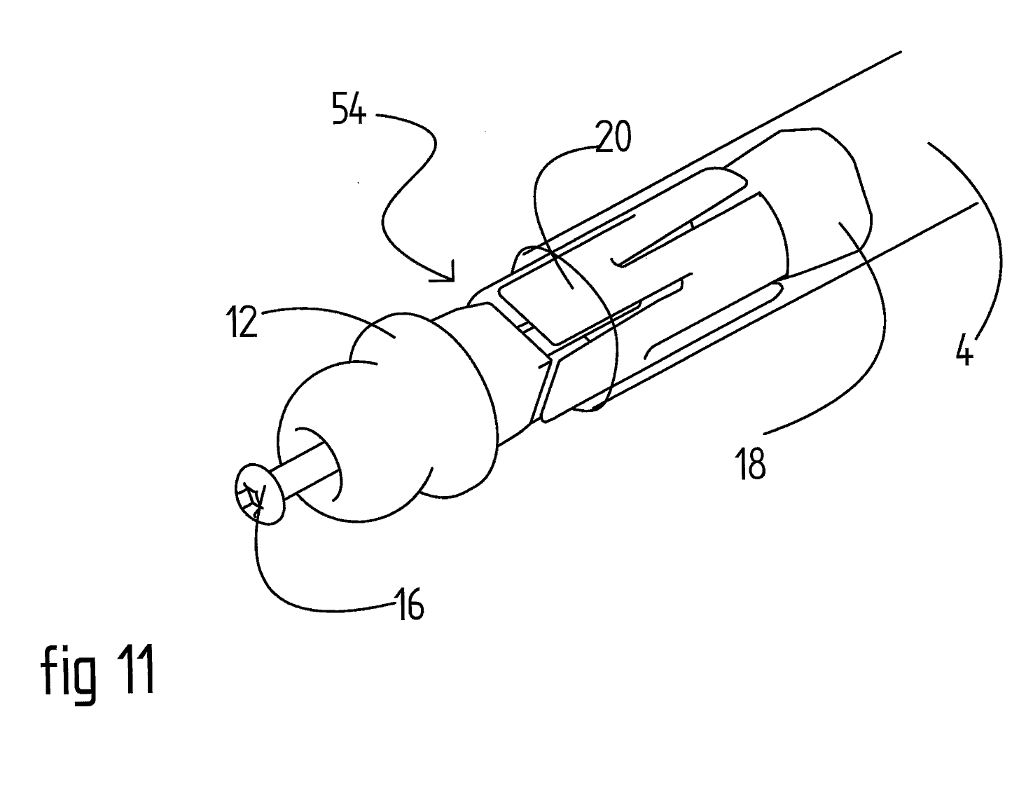

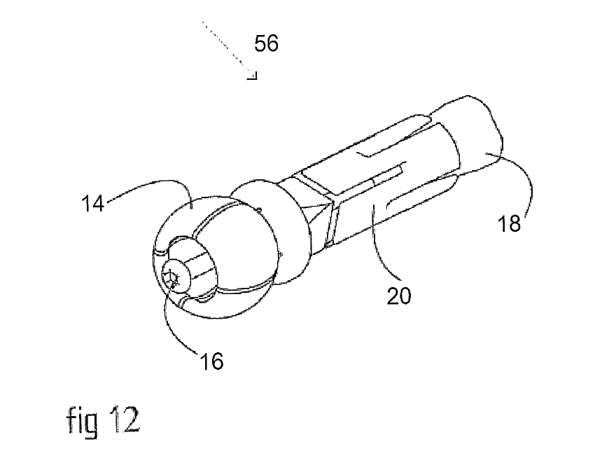

FIGS. 11 and 12 show a bicycle connector, according to another embodiment of the present invention.

The connector of the present embodiment includes a male member 54 and a female member 56. Members 54 and 56 are straight as being suited to straight handles of bicycles.

Upon the torque, nut 16 does not protrude, thus enabling male edge 12 of member 54 enter female edge 14 of member 56.

Members 6, 8, 54, and 56 may be combined otherwise. For instance bent male member 6 may engage straight female member 56 for connecting a bent handle 4 with a straight handle 4.

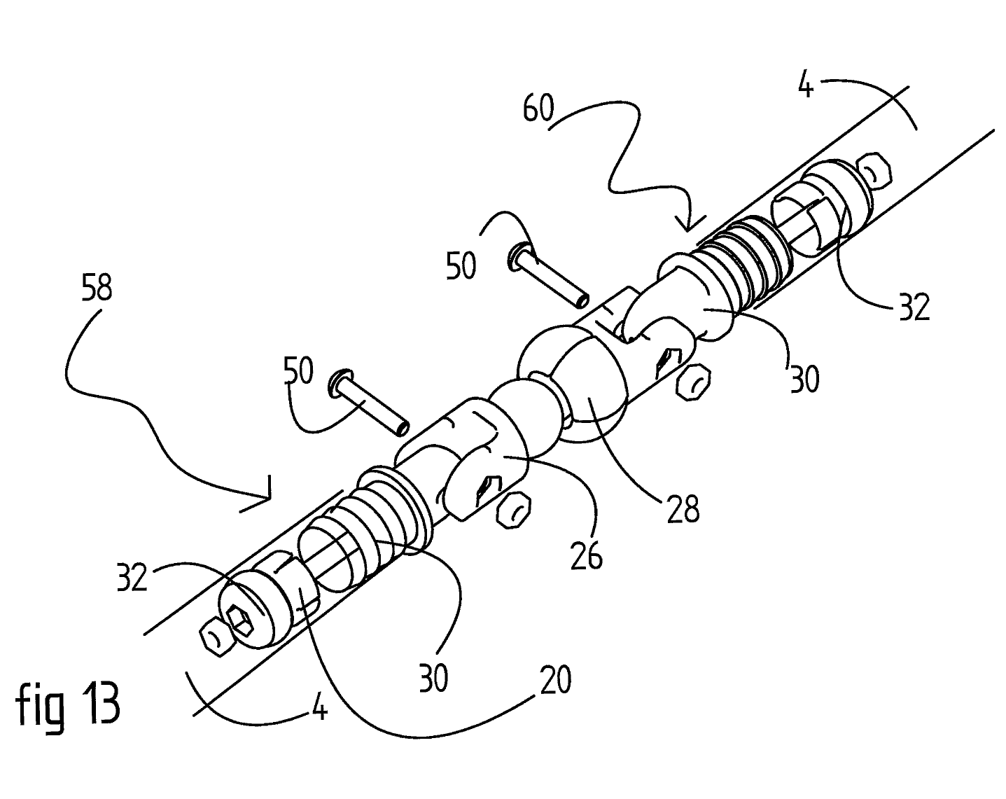

FIG. 13 shows a bicycle connector, according to another embodiment of the present invention.

The connector of FIG. 13 includes a male member 58 having a male edge 26 at the right and a wedge anchor mechanism inserted into a handle 4 of a bicycle. Also the connector includes a female member 60 having a female edge 28 at the left thereof and a wedge anchor mechanism inserted into another handle 4 of a bicycle. Male edge 26 and female edge 28 may be engaged together for connecting the two bicycles, represented by handles 4.

Hinges 50 may allow adjustment of the angle, such as for matching height differences between the bicycles.

According to this embodiment conical anchor 30 expands clip 20 upon torque of a nut, which is accessible by dismantling hinge 50.

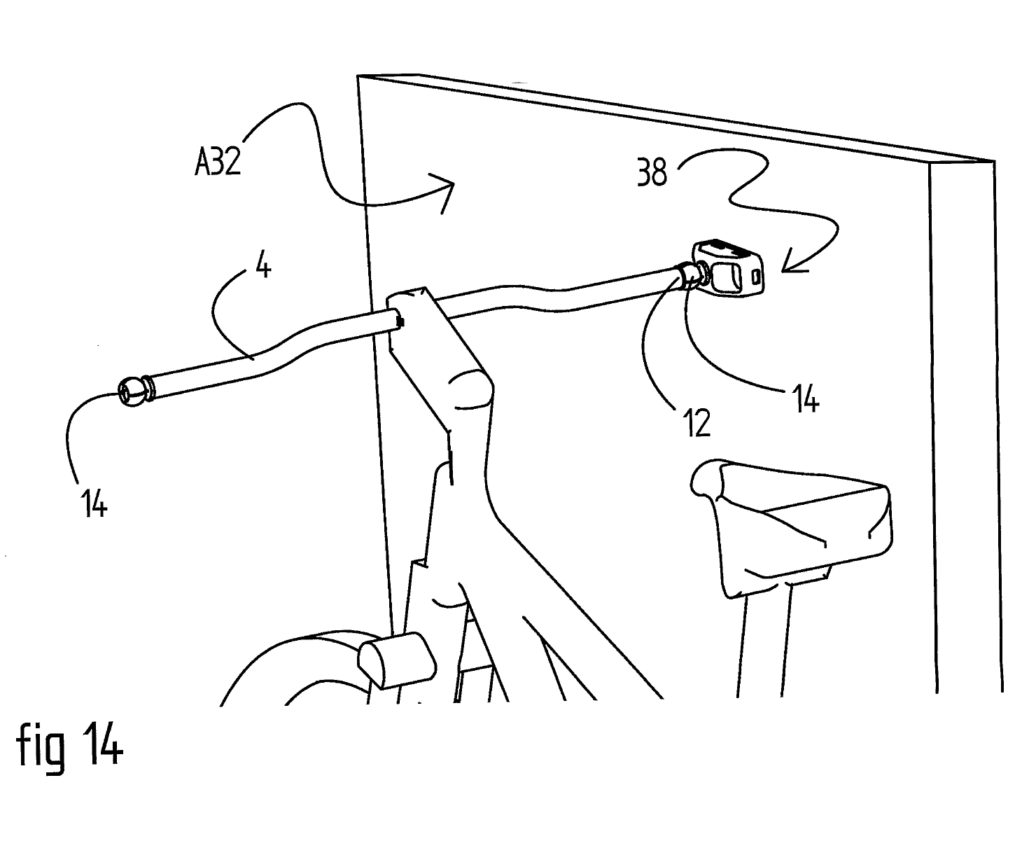

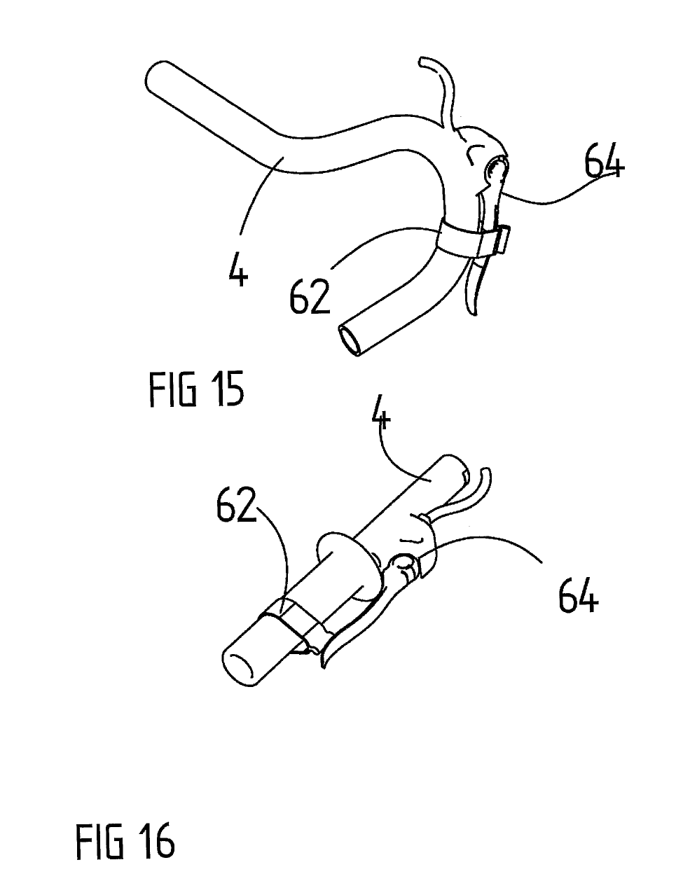

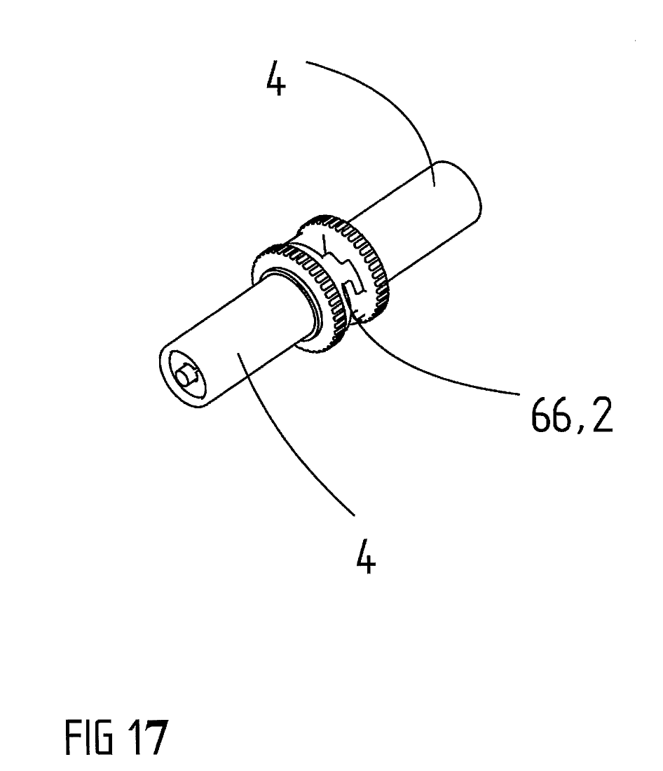

FIG. 14 shows a wall mounted device for a bicycle, according to one embodiment of the present invention, which is based on one of the connectors,

A wall mounted device 38 may be mounted to a wall, to a fence, or to another standing object 32a at the height of the handle 4 of the bicycle.

Wall mounted device 38 may include female edge 14 for connecting a male edge 12, which is mounted to handle 4 of the bicycle. According to another embodiment, device 38 may include male edge 12 for connecting a female edge 14, which is mounted to handle 4 of the bicycle.

Wall mounted device 38 allows parking the bicycle upright without another bicycle or a kickstand.

FIG. 15 depicts a brake limiter for a bicycle, according to one embodiment of the present invention.

In order to avoid sliding of the bicycles, each brake 64 may be limited to the braked position thereof. A ring 62 may limit brake 64, being a brake limiter.

FIG. 16 shows the brake limiter of FIG. 15 for a straight handle, whereas FIG. 15 depicts a bent handle 64.

FIG. 17 shows a connector according to another embodiment.

Connector 2 between handles 4 of two bicycles may include a torque quick coupling 66. The two members of torque coupling 66 may be connected or disconnected by torque movement of one of the members. Preferably the two members are identical, thus allowing providing a single component for connecting all bicycles.

In the figures and/or description herein, the following reference numerals have been mentioned:

numeral 2 denotes a bicycle connector according to one embodiment of the present invention;

numeral 4 denotes a handle of the bicycle;

numeral 6 denotes a male member of a bicycle connector according to another embodiment of the present invention;

numeral 8 denotes a female member of the bicycle connector;

numeral 10 denotes a bicycle;

numeral 12 denotes a male edge of a male member of the connector;

numeral 14 denotes a female edge of a female member of the connector;

numeral 16 denotes a nut of a wedge anchor;

numeral 18 denotes a conical anchor of a wedge anchor;

numeral 20 denotes a clip of a wedge anchor;

numeral 22 denotes a sleeve of the bicycle connector, for inserting the handle of the bicycle therein;

numeral 24 denotes a linker for connecting two members, each mounted to a handle of a bicycle;

numeral 26 denotes a male edge of another male member;

numeral 28 denotes a female edge of another female member;

numeral 30 denotes another conical anchor;

numeral 32 denotes a second bicycle at the side of the first bicycle, for parking both bicycles;

numeral 32a denotes a wall or another object at the side of the first bicycle, for parking the first bicycle upright;
numeral 34 denotes a grasp of a bicycle connector;

numeral 36 denotes a hinge;

numeral 38 denotes a wall mounted device, for connecting a bicycle thereto;

numeral 42 denotes a female member of a bicycle connector;

numeral 44 denotes a male member of a bicycle connector;

numeral 46 denotes elastic reeds for connecting a handle of a bicycle;

numeral 48 denote elastic reeds of a female member for connecting a male member of the bicycle connector;

numeral 50 denotes a hinge;

numeral 54 denotes a male member of a bicycle connector;

numeral 56 denotes a female member of a bicycle connector;

numeral 58 denotes a male member of another bicycle connector;

numeral 60 denotes a female member of that bicycle connector;

numeral 62 denotes a brake limiter;

numeral 64 denotes the handle of the brake of the bicycle; and

numeral 66 denotes a torque quick coupling, being another embodiment of the connector.

The foregoing description and illustrations of the embodiments of the invention has been presented for the purposes of illustration. It is not intended to be exhaustive or to limit the invention to the description above in any form.

1. A device for parking a first two-wheeled vehicle upright, said device comprising:
a detachable connector, for detachably connecting a side end of a handle of said first two-wheeled vehicle to an end of an adjacent second two-wheeled vehicle or to an adjacent stationary object.

2. A device according to claim 1, wherein said connecting of said first two-wheeled vehicle to said end of said adjacent second two-wheeled vehicle or to said adjacent stationary object comprises connecting said first two-wheeled vehicle to said connector.

3. A device according to claim 2, wherein said connector comprises a first and a second grasp mounted together, said first grasp for grasping said first two-wheeled vehicle, and said second grasp for grasping said end of said adjacent second two-wheeled vehicle or to said adjacent stationary object.

4. A device according to claim 3, wherein said mounting together of said first and second grasps comprises at least one hinge, for adjusting therebetween.

5. A device according to claim 1, wherein said connecting of said side end of said handle of said first two-wheeled vehicle to said end of said adjacent second two-wheeled vehicle or to said adjacent stationary object comprises connecting a first connecting member of said connector to a second connecting member of said connector, wherein said first connecting member is mounted to said first two-wheeled vehicle.

6. A device according to claim 5, wherein said connector comprises:
said first connecting member mounted to said handle of said first two-wheeled vehicle, said first connecting member comprising a first half of connecting means; and
a second connecting member mounted to said end of said adjacent second two-wheeled vehicle or to said adjacent stationary object substantially at the height of said handle of said first two-wheeled vehicle, said second connecting member comprising a second half of said connecting means.

7. A device according to claim 6, wherein said connecting means between said two halves comprises elastic means.

8. A device according to claim 6, wherein said connecting means between said two halves comprises magnetic means.

9. A device according to claim 6, wherein said first half of said connecting means comprises a male edge, and said second half of said connecting means comprises a corresponding female edge.

10. A device according to claim 6, wherein said mounting of said first connecting member to said handle comprises insertion of said handle into an elastic sleeve of said first connecting member.

11. A device according to claim 6, wherein said mounting of said first connecting member to said handle comprises insertion of a wedge anchor of said first connecting member into the inner space of said handle, expanding a clip of said wedge anchor against the sidewalls of said inner space.

12. A device according to claim 6, wherein said first connecting member and said second connecting member comprise a combination selected from the following:
said first connecting member is straight and said second connecting member is bent,
said first connecting member is straight and said second connecting member is straight,
said first connecting member is bent and said second connecting member is bent,
said first connecting member is bent and said second connecting member is straight.

13. A device according to claim 6, wherein said second connecting member comprises:
a third connecting member identical to said first connecting member; and
a linker, for linking said first connecting member to said third connecting member, said linker comprising connecting means corresponding to said connecting means of said first and third connecting members, for connecting between said first connecting member and said linker, and for connecting between said third connecting member and said linker.

14. A device according to claim 1, further comprising:
a brake limiter, for limiting the brake of said first two-wheeled vehicle during said parking,
thereby avoiding sliding of said first two-wheeled vehicle during said parking

15. A device according to claim 3, wherein said first and second grasps comprise at least one torque quick coupling.

16. A device according to claim 3, wherein said first and second grasps are identical components.

17. A method for parking a first two-wheeled vehicle upright, said method comprising the step of:
detachably connecting a side end of a handle of said first two-wheeled vehicle to an end of an adjacent second two-wheeled vehicle or to an adjacent stationary object.

18. A method according to claim 17, further comprising the step of:
disconnecting said side end of said handle of said first two-wheeled vehicle from said end of said adjacent second two-wheeled vehicle or from said adjacent stationary object.

19. A method according to claim 17, wherein the step of connecting comprises the steps of:
connecting a linker to said first two-wheeled vehicle; and
connecting said linker to said end of said adjacent second two-wheeled vehicle or to said adjacent stationary object.

20. A method according to claim 17, further comprising the step of:
limiting the brake of said first two-wheeled vehicle to the braked state thereof, thereby avoiding sliding of said first two-wheeled vehicle during said parking.
